(19) United States
(12) Patent Application Publication
(10) Pub. No.: US 2013/0141671 A1
(43) Pub. Date: Jun. 6, 2013

(54) LIQUID CRYSTAL DISPLAY DEVICE, BACKLIGHT UNIT, AND HEAT DISSIPATING METHOD THEREOF

(71) Applicant: Ye-Wen Wang, Shenzhen (CN)

(72) Inventor: Ye-Wen Wang, Shenzhen (CN)

(21) Appl. No.: 13/496,103

(22) PCT Filed: Dec. 21, 2011
(86) PCT No.: PCT/CN11/84316

§ 371 Date: Mar. 14, 2012

(30) Foreign Application Priority Data
Dec. 2, 2011 (CN) 201110396056.X

(51) Int. Cl. G09F 13/04; G02F 1/13357; F21V 29/00

(52) U.S. Cl. 349/69; 362/97.1

(57) ABSTRACT

Provided is a liquid crystal display device, a backlight unit, and a heat dissipating method thereof. The backlight unit includes light bar formed with LED and substrate; and heat dissipating structure attached to the substrate of the light bar; wherein, the connection between the substrate and the heat dissipating structure is made of graphite material. According to abovementioned method may accelerate the LED heat dissipation, lower the junction temperature, extend the LED lifespan, and thereby extending the LCD lifespan with lighter weight and lower cost.

### FIELD OF THE INVENTION

The present invention relates to a liquid crystal display device, and more particularly to a heat dissipating structure of a backlight unit of the liquid crystal display device.

### BACKGROUND OF THE INVENTION

Liquid crystal display device employing liquid crystal for displaying images generally comprises liquid crystal panel, backlight unit, related digital circuits, and power source. Heat dissipation of LED is in relation to light attenuation and the lifespan thereof, and relates to the junction temperature wherein poor heat dissipation leads to higher junction temperature and therefore shorter LED lifespan. Further, the heat also causes problems such as spectral shift, color temperature rise, forward current increase (while supplying constant voltage), reverse current increase, thermal stress increase, and phosphor epoxy resin degradation acceleration. Hence, with the number of LED for backlight use decreases, and the size and the brightness of single LED package increases, such as an LED package specification being upgraded to 7030 or the brightness of an LED, of which the package specification is 5630, being increased to 36 1 m, solving the heat dissipation problem is now a crucial issue.

One of the prior heat dissipating methods, as disclosed in U.S. Pat. No. US7,527,408 B2, includes a backlight unit which generally comprises: (from bottom to top) heat dissipating layer; reflector; light source; transparent sheet; diffuser; prism sheet; protective sheet; and polarizer. The heat dissipating layer is formed with thermal conductive particles with excellent thermal conductivity coefficient made of graphite powder, Cu, Ag, Al and the mixture thereof. Therefore, the heat dissipating layer is capable of absorbing heat transmitted to the reflector and dissipating the heat through back board to the outside of the liquid crystal display device.

Another prior heat dissipating method includes a plurality of backlight LED installed on the Metal Core PCB (MCPCB) to form a side-type LED light bar. The LED light bar may realize heat dissipation by installing the MCPCB to the heat dissipating structure and the heat dissipating structure to the backplate. Wherein, the heat dissipating structure is made of material with better thermal conductivity such as Al, and Cu. With the thermal conductivity of the material limited, it is often required to increase the size of the heat dissipating structure in order to improve heat dissipating ability, and thereby increasing the quality and the cost thereof.

### SUMMARY

In order to overcome the deficiencies of the prior art, a primary object of the present invention is to provide a heat dissipating structure of a backlight unit which is capable of accelerating the LED heat dissipation, lowering the junction temperature, extending the LED lifespan, and thereby extending the LCD lifespan with lighter weight and lower cost.

To solve the technical problems above, the present invention provides a heat dissipating method for a backlight unit, wherein the backlight unit includes light bar formed with LED and substrate; the light bar performs heat dissipation through attaching the substrate thereof to a heat dissipating structure, wherein the connection between the substrate and the heat dissipating structure is made of graphite material.

To solve the technical problems above, the present invention further provides a backlight unit including the light bar formed with LED and substrate, and heat dissipating structure attached to the substrate of the light bar; wherein, the connection between the substrate and the heat dissipating structure is made of graphite material.

The entire heat dissipating structure is made of graphite material. Alternatively, the surface of the connection between the substrate and the heat dissipating structure is made of graphite material. Alternatively, the heat dissipating structure includes main body and sheet body individually separated from and corresponding to each other, wherein the sheet body is made of graphite material and is disposed between the main body and the substrate.

The substrate is attached to the heat dissipating structure through adhesive, wherein graphite powder is added to the adhesive.

The backlight unit further comprises backplate, on which the heat dissipating structure is installed. The heat dissipating structure has two parts perpendicular to each other, wherein a first part is attached to the substrate of the light bar, and a second part is attached to the backplate.

To solve the technical problems above, the present invention further provides a liquid crystal display device including the aforementioned backlight unit.

Compared with the prior art, the present invention providing the liquid crystal display device, backlight unit, and the heat dissipating method thereof employs excellent heat dissipation characteristics of graphite by making graphite the material of the connection between the substrate and the heat dissipating structure, thereby allowing the present invention to accelerate the LED heat dissipation, lowering the junction temperature, extending the LED lifespan, and thus extending the LCD lifespan with lighter weight and lower cost.

### BRIEF DESCRIPTION OF THE DRAWINGS

FIG. 1 is a structural diagram illustrating a backlight unit according to the present invention.

### DETAILED DESCRIPTION OF THE EMBODIMENTS

Reference will now be made in detail to the preferred embodiment of the present disclosure, examples of which are illustrated in the accompanying drawings.

The present invention providing the liquid crystal display device, backlight unit, and the heat dissipating method thereof employs excellent heat dissipation characteristics of graphite to improve the thermal conductivity of the heat dissipating structure in whole and/or in part, wherein “in part” refers to the connection between the substrate and the heat dissipating structure, in order to accelerate the heat dissipation of the LED.

The characteristics of graphite mainly includes: the surface thereof is capable of combining with other materials such as metal, plastic, self adhesive, in order to satisfy more design features and requirements; 40% lower than Al and 20% lower than Cu in heat resistance; and 25% lower than Al and 75% lower than Cu in weight. Further, graphite heat dissipating sheet may be tightly attached to any flat and curved surface, allowing a broad application.

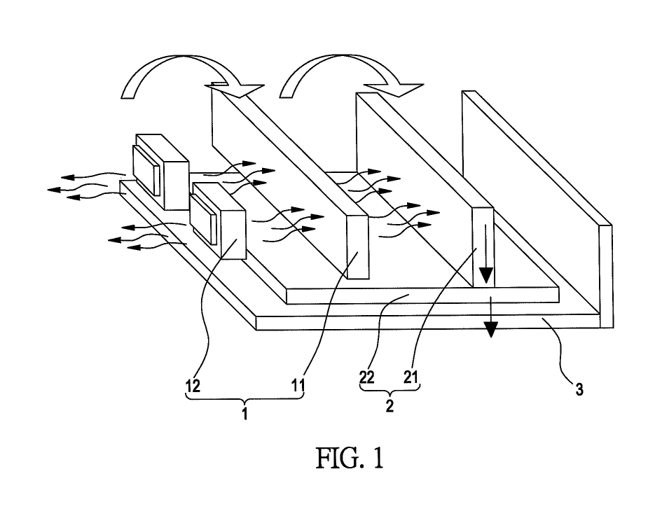

Referring to FIG. 1, the backlight unit of the present embodiment includes: a light bar 1 comprised LED 12 and MCPCB substrate 11; a heat dissipating structure 2 attached to the substrate 11 of the light bar 1; and a backplate 3.

The heat dissipating structure 2 has two parts perpendicular to each other, wherein a first part 21 is attached to the substrate 11 of the light bar 1, and a second part 22 is attached to the backplate 3.

In a mode for the present invention, the entire heat dissipating structure 2 is realized by graphite heat dissipating sheet or graphite foam.

In another mode for the present invention, the entire heat dissipating structure 2 includes a main body made of metal material and a graphite layer sputtering onto the surface of the main body.

In yet another mode for the present invention, the light bar 1 and the heat dissipating structure 2 perform attachment with screws or adhesive, wherein graphite powder is added to the adhesive.

In other modes for the present invention, the heat dissipating structure 2 includes a main body and a sheet body individually separated from and corresponding to each other, wherein the sheet body is made of graphite material and is disposed between the main body and the substrate 11 of the light bar 1.

In other modes for the present invention, the substrate 11 may include the graphite layer sputtering onto an Al surface of the bottom layer thereof; in other words, surface of the connection between the substrate 11 and the heat dissipating structure 2 is made of graphite material.

It is to be understood that the aforesaid heat dissipating structure 2 may be an existing and separate heat dissipating member made of metal material, or may be realized with the structure/parts on the backplate as a whole, and omit the existing metal heat dissipating member; that is, the heat dissipating structure 2 and the backplate 3 are one structure.

Compared with the prior art, by using the above-mentioned backlight unit, the liquid crystal display device may reduce the its weight and extend its lifespan.

The previous description of the preferred embodiment is provided to further describe the present invention, not intended to limit the present invention. Any modification apparent to those skilled in the art according to the disclosure within the scope will be construed as being included in the present invention.

What is claimed is:

1. A heat dissipating method of a backlight unit, wherein the backlight unit includes a light bar comprising LED and a substrate; attaching the substrate thereof and a heat dissipating structure for the light bar performs heat dissipation, wherein the connection between the substrate and the heat dissipating structure is made of graphite material.

2. The heat dissipating method of claim 1, wherein the entire heat dissipating structure is made of graphite material; or, the surface of the connection between the substrate and the heat dissipating structure is made of graphite material; or, the heat dissipating structure including a main body and a sheet body individually separated from and corresponding to each other, wherein the sheet body is made of graphite material and is disposed between the main body and the substrate.

3. The heat dissipating method of claim 1, wherein the substrate attaching to the heat dissipating structure through an adhesive, wherein graphite powder is added to the adhesive.

4. The heat dissipating method of claim 1, wherein the backlight unit further comprises a backplate, on which the heat dissipating structure is installed.

5. The heat dissipating method of claim 4, wherein the heat dissipating structure has two parts perpendicular to each other, wherein a first part is attached to the substrate of the light bar, and a second part is attached to the backplate.

6. A backlight unit, including a light bar comprised of LED and a substrate, and attaching the substrate of the light bar to a heat dissipating structure; wherein, the connection between the substrate and the heat dissipating structure is made of graphite material.

7. The backlight unit of claim 6, wherein the entire heat dissipating structure is made of graphite material; or, surface of the connection between the substrate and the heat dissipating structure is made of graphite material; or, the heat dissipating structure including a main body and a sheet body individually separated from and corresponding to each other, wherein the sheet body is made of graphite material and is disposed between the main body and the substrate.

8. The backlight unit of claim 6, wherein the substrate is attached to the heat dissipating structure through an adhesive, wherein graphite powder is added to the adhesive.

9. The backlight unit of claim 6 further comprises a backplate, on which the heat dissipating structure is installed; wherein the heat dissipating structure has two parts perpendicular to each other, a first part is attached to the substrate of the light bar, and a second part is attached to the backplate.

10. A liquid crystal display device, comprising the backlight unit of claim 6.
